(19) United States
(12) Patent Application Publication
(10) Pub. No.: US 2011/0214760 A1
(43) Pub. Date: Sep. 8, 2011

(54) Screw top liqid dispensing chamber

(76) Inventor: Emile Ortiz Greaves, Pickering (CA)

(21) Appl. No.: 12/660,921

(22) Filed: Mar. 8, 2010

(51) Int. Cl. F16K 15/00

(52) U.S. Cl. 137/519.5

(57) ABSTRACT

The invention is a device which works similar to a ‘liquor dispenser’. To use the invention the original cap on the beverage carton must be screwed off. The invention screws onto a screw top beverage carton (usually milk/cream carton also referred to as a Gable Top Carton usually made of a cardboard type material). It has a straight pour spout which always keep the spout in pouring position and two chambers. These chambers contain steel balls that function according to angle and pressure when the invention is secured onto the beverage carton threaded neck and is raised to pour liquid into a cup. The steel ball in the main chamber acts as a stopper. This occurs when a specified amount of liquid has rushed through the two side hollow windows of the chamber and out of the spout. When the ball rolls to the top wall of the main chamber it blocks excessive liquid from exiting the spout thus creating a measured serving. This invention is unique because it attaches to the neck of the screw cap housing located atop of a beverage carton by means of an internal thread. The invention is externally located with the chamber reaching inside of the beverage carton just past the beginning of the beverage carton neck.

The invention is similar to a ‘liquor dispenser’ that is made to fit onto a bottle. The invention is a ‘screw top liquid dispenser’ or ‘gable top liquid dispenser’. This invention is secured to the threaded neck of a milk/cream carton, also referred to as a Gable Top Carton which is usually made of a cardboard type material. The invention is a device which consists of the following: a main chamber, may or may not consist of a side venting channel, spout (straight), housing (cap) which contains threads, connecting chamber, steel balls, two side hollow openings. The invention works much like a “liquor dispenser”. To use the invention first screw off the cap found on the carton's neck and screw on the invention. There is a straight spout attached to the chamber always keeping the invention in pouring position. The main chamber is tube like and contains a steel ball which travels through it when the device is raised to approximately a 45 degree angle. When the device is raised (during a pouring manner) the ball moves from the bottom of the chamber to the top of the chamber. While in this action, liquid rushes through two side hollow windows located at the top of the chamber. The ball quickly follows the liquid stopping excessive liquid from flowing through the top of the chamber exiting through the spout. (The side venting chamber allows air flow to assist in a smoother pour, this may or may not be constructed onto the main chamber or connecting chamber). A measured amount of liquid has gone through the spout via the two side openings or windows, performing a measured serving of liquid to fall into a cup. The connecting chamber (smaller chamber which houses a steel ball) acts as an assisting pressure device allowing the steel ball to roll more freely down the main chamber. The connecting chamber is separated from the main chamber by a wall. When the pour is completed and the beverage carton is turned to a standing position, the steel ball rolls down to the bottom of the chamber resting at the separating wall in position for the next pour. The threads which are located on the bottom part of the invention are specially designed to fit onto the threads of a beverage carton, fitting and sealing the neck creating a snug fit and not allowing leakage. The invention is not designed to be used on a bottle, it is designed to be used on a beverage carton usually milk/cream.

In the case of an apparatus one must screw off the cap found on the carton's neck and screw on the invention FIG. 4. There is a straight spout 4 attached to the chamber 4 (the main chamber is the continuation of the spout) always keeping the invention in pouring position. The main chamber 4 is tube like and contains a steel ball 3 which travels through it when the device is raised to approximately a 45 degree angle. When the device is raised (during a pouring manner) the ball 3 moves from the bottom of the chamber 4 to the top of the chamber 4. While in this action, liquid rushes through two side hollow windows 8 located at the top of the chamber 4. The ball 3 quickly follows the liquid stopping excessive liquid from flowing through the top of the chamber 4 exiting through the spout 4. (The side venting chamber allows air flow to assist in a smoother pour, this may or may not be constructed onto the main chamber or connecting chamber). A measured amount of liquid has gone through the spout 4 via the two side openings or windows 8, performing a measured serving of liquid to fall into a cup. The connecting chamber 6 (smaller chamber which houses a steel ball 7) acts as an assisting pressure device allowing the steel ball 3 to roll more freely down the main chamber 4. The connecting chamber 6 is separated from the main chamber 4 by a wall. When the pour is completed and the beverage carton is turned to a standing position, the steel ball 3 rolls down to the bottom of the chamber 4 resting at the separating wall 6 in position for the next pour. The threads 2 which are located on the bottom part of the invention are specially designed to fit onto the threads of a beverage carton, fitting and sealing the neck creating a snug fit and not allowing leakage. The invention is not designed to be used on a bottle, it is designed to be used on a beverage carton usually milk/cream.

### BACKGROUND OF THE INVENTION

The invention relates to a beverage carton usually milk/cream. The invention attaches to a neck of a beverage carton to act as a device which controls measured pours of liquid such as milk or cream. There are no electronics contained within the invention nor is electricity needed to use the invention. The invention is ideal for businesses using milk or cream as an additive to their drinks as it controls portion servings cutting down on beverage costs.

### SUMMARY

The invention is essentially a small portable liquid measuring device that fits onto beverage cartons made with a threaded neck. The invention allows for businesses such as fast food or retail coffee shops to lessen the wasted portions of milk or cream when not using a measuring device for the purpose of adding milk or cream to a beverage or similar. This saves businesses money and saves time during the process of making, for example, a cup of coffee or tea for customers when milk or cream is desired to complete the drink.

### DESCRIPTION OF DRAWINGS FIG. 1, FIG. 2, FIG. 3

FIG. 1 shows a top view of the invention.

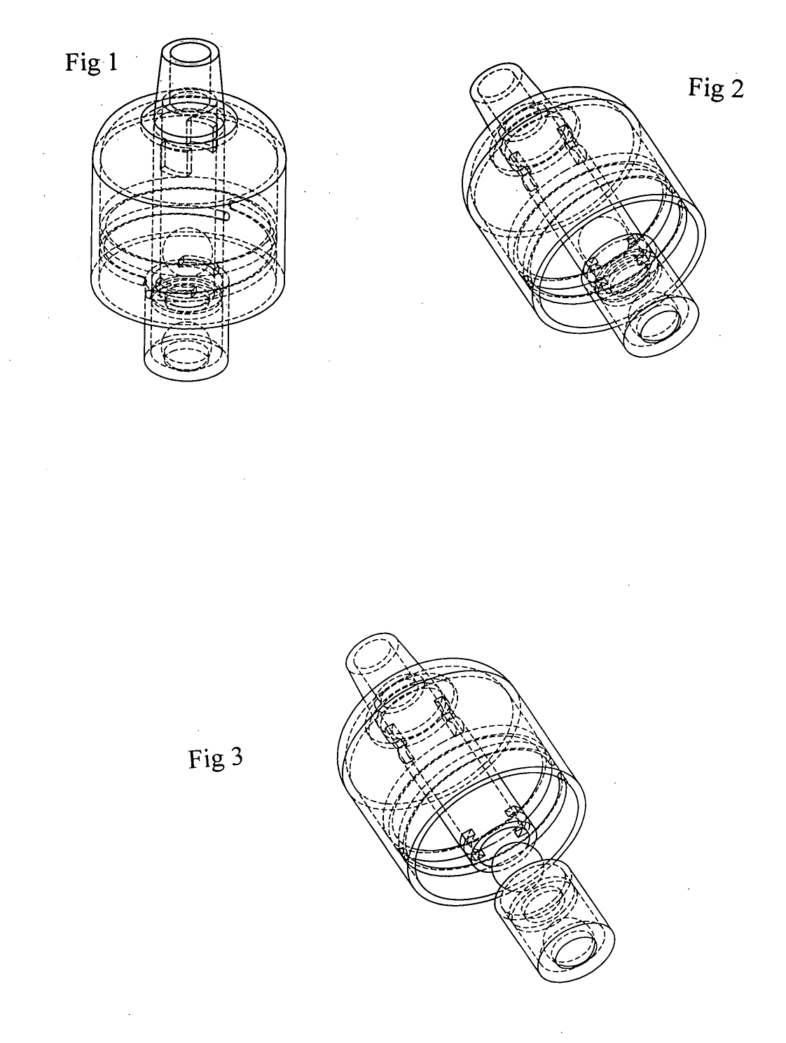

FIG. 2 shows a bottom view of the invention.

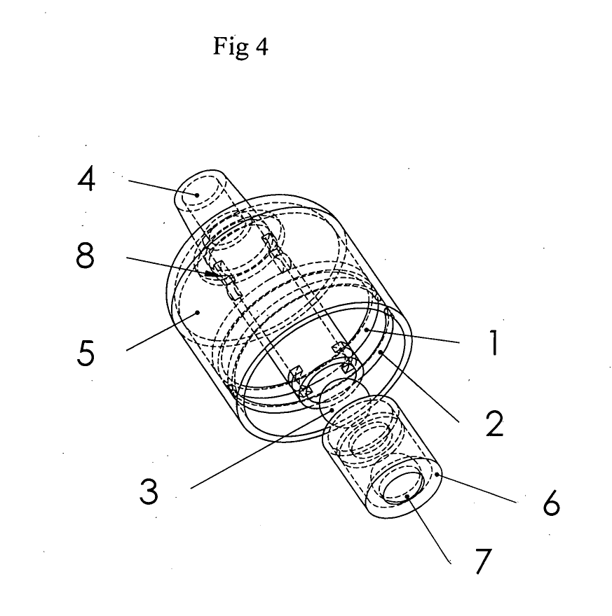

FIG. 3 shows a side view of the invention.

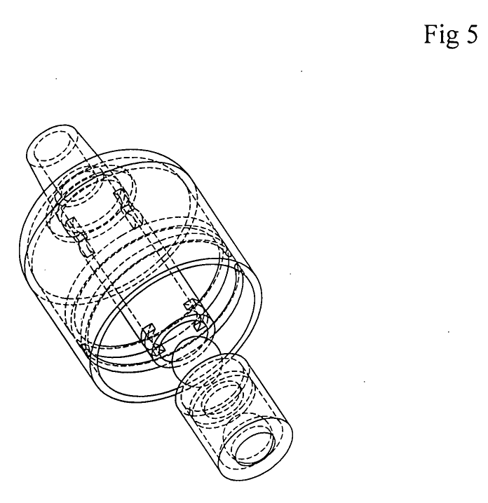

### DRAWINGS

FIG. 4 A side view of the invention marked

FIG. 5 A side view of the invention unmarked

### DESCRIPTION OF DRAWING) FIG. 4

FIG. 4:1) Ring inside to stops leakage

FIG. 4:2) Threads to match cartridge of various carton brands

FIG. 4:3) Steel ball (stainless)

FIG. 4:4) Straight spout/Main Chamber

FIG. 4:5) Cap/Housing

FIG. 4:6) Connecting Chamber

FIG. 4:7) Steel ball (stainless)

FIG. 4:8) Entry holes/Hollow windows

1. The invention consists of a ‘main’ chamber which near the top are 2. two side hollowed windows or openings. The main chamber is tube like in form and can be made of plastic or steel, it may or may not have a side venting chamber. The main chamber houses a 3. steel ball which runs up and down. There is a 4. connecting chamber which houses a second 5. steel ball, this is separated from the main chamber. This is located at the bottom of the main chamber. At the top of the main chamber is the 6. straight spout. Surrounding the main chamber is the 7. cap or ‘housing’. The spout protrudes through a hole and seals itself to the cap. 8. Threads are located at the bottom of the cap. The cap and main chamber are fitted together via the spout which is connected to the main chamber which is connected to the connecting chamber. The invention screws onto the beverage/milk carton's threaded neck via its internal threads. Simply turn or screw on and it secures creating a ‘snug’ tight fit preventing leakage.
